(19) United States
(12) Patent Application Publication
(10) Pub. No.: US 2009/0061180 A1
(43) Pub. Date: Mar. 5, 2009

(54) DICHROIC MIRROR

(76) Inventors: Laurent Aumercier, Sarre-Union (FR); Pierre Andre Dreidemy, Sarre-Union (FR)

Correspondence Address: AKERMAN SENTERFITT, P.O. BOX 3188, WEST PALM BEACH, FL, 33402-3188, US

(21) Appl. No.: 11/577,527

(22) PCT Filed: Oct. 27, 2005
(86) PCT No.: PCT/US05/55605

§ 371 Date: Apr. 19, 2007

(30) Foreign Application Priority Data
Oct. 29, 2004 (EP) 04105400.8

(51) Int. Cl. B32B 7/02; C03C 17/34; C03C 17/36

(52) U.S. Cl. 428/212

(57) ABSTRACT

Dichroïc mirrors, also known as optical filters, having a particular use as a rear view mirror includes a vitreous substrate coated with a stack of interferential layers and with a metallic reflector. The stack of layers includes, successively from the substrate, a layer of high refractive index material in the range of 1.9 to 2.8, a layer of a lower refractive index material in the range of 1.2 to 2.2, and a layer of a semiconductor material having a refractive index of more than 3. The refractive indices of the layers of high refractive index material and lower refractive index material differ by at least 0.2 and the coated substrate has a transmittance at 550 nm of at least 6% and a reflectance at 550 nm greater than 45%.

The present invention concerns dichroïc mirrors also known as optical filters. In particular, the invention relates to a rear view mirror comprising a vitreous substrate coated with a stack of interferential layers and with a metallic reflector.

Several constructions comprising a system combining a rear view mirror with a display, an emitter and/or electromagnetic sensor hidden behind the mirror surface are known. In these systems, the display/emitter or sensor operates trough the mirror while the mirror itself reflects what is expected from its function thanks to a specific coating arrangement which has simultaneously (1) the ability to reflect a significant portion of the visible spectrum and (2) can transmit a sufficient amount of the electromagnetic radiations emitted by the display/emitter and/or absorbed by the sensor.

All these systems installed on road vehicles usually exhibit a reflectance rate comprised between 35 and 55% (typically measured according to SAE J964 or equivalent procedure), and are often built with the reflecting layer(s) placed on the front surface of the mirror compared to the position of the observer. This embodiment maximizes the reflectance and the transmittance simultaneously, a quite challenging task when they both have to cover more or less same portions of the electromagnetic spectrum.

In some cases, system constructions using a reflective layer on the front surface is not advantageous and there is therefore a need for a dichroïc mirror comprising a stack of interferential layers on the rear surface. When using rear face construction, the transmittance rate is usually sacrificed on behalf of the reflectance rate. For example, when using a thin layer of chromium as reflector, it is known that the following values can be obtained:

| Reflectance* % | Transmittance* % |
|---|---|
| 58.8 | 1.4 |
| 53.7 | 5.1 |
| 45.4 | 9.4 |
| 40.8 | 12.1 |
| 35 | 15.4 |

*reflectance and transmittance as measured here are according to SAE J964 procedure. They signify integrated values over the visible spectrum.

One can then understand that almost no light is transmitted once the reflectance exceeds 58-60%.

It has been discovered that the use of a stack of interferential layers and a suitable metallic reflector according to the invention, on the rear surface of the substrate, can enhance both the transmittance and the reflectance rates.

The object of the present invention is a vitreous substrate, having a front surface and a rear surface, coated on its rear surface with a stack of layers including, successively from the substrate,
i) one layer of a high refractive index material in the range of 1.9 to 2.8,
ii) one layer of a lower refractive index material in the range of 1.2 to 2,
iii) one layer of semiconductor material having a refractive index of more than 3,
   wherein the refractive indexes of high refractive index materials and of the low refractive index materials differ at least by 0.2, and
   the optical thickness (geometrical thickness×refractive index) of layer i) being lower than 260 nm preferably lower than 250 nm, and the optical thickness of layer ii) being lower than 240 nm, preferably lower than 220, and
   the coated substrate having a transmittance at 550 nm of at least 6%, preferably at least 8% and a reflectance at 550 nm greater than 45%, preferably greater than 50%.

Advantageously, the object of the invention is as disclosed in the dependant claims. The coated substrate can have a blue tint in reflection but it can also presents a neutral tint in reflection. In this case, the calorimetric Hunter values a* and b* are preferably comprises between −10 and +10 and the purity is preferably lower than 13%, more preferably lower than 10%.

The system is particularly interesting in prismatic interior day/night rear view mirrors. The reflector has to be behind the glass to offer a high reflectance “day position”. The front surface of the glass itself, with its own refractive index, gives the low reflectance level of the commonly called “night position”. Simultaneously with our invention, the transmittance is kept at sufficient level to allow the use of display/emitter and/or sensor devices placed behind the mirror.

The invention can also be used in “self dimming”, sometime called “electrochromic” automatic day/night rear view mirrors where the highest possible reflectance of the mirror is required to increase the device optical range.

Such system can be applied on any suitable transparent substrate (for example glass or plastic), by all known means from the state of the art for such construction, for example dipping, pyrolitic deposition process as Chemical Vapor Deposition (CVD), or Physical Vapor Deposition (PVD) or the combination of any of these techniques.

Another interesting advantage of our constructions is to be durable so as to permit manufacturing handling without deterioration (mechanical—scratch resistance) and to have a substantial self protection against corrosion (climatic stability).

### EXAMPLES

In the following examples, rear view dichroïc mirrors was formed by coating the rear face (the face opposite of the observer) of a sodo-lime glass substrate with different stack of layers. The layers are deposited by magnetically enhanced vacuum sputtering deposition process. In a way commonly known by the skilled man, the glass passed through successive deposition chambers where the appropriate targets materials are bombarded under vacuum.

### Example 1

The coated substrate, viewed form the observer, consists in:

Glass 2 mm/TiO₂ 60 nm/SiO_{2 50} nm/Cr 20 nm

This structure gives the following optical characteristics:

| | |
|---|---|
| reflectance at 550 nm | 63% |
| transmittance at 550 nm | 6% |
| transmittance at 400 nm | 8% |
| transmittance at 700 nm | 12% |
| transmittance at 800 nm | 15% |

Other interesting combinations exist with the same materials when their respective thickness are in the range of

Glass (0.4 to 6 mm)/TiO₂ (30 to 100 nm)/SiO₂ (30 to 100 nm)/Cr (10 to 30 nm)

### Example 2

The structure is similar to that of example 1, but for the reflector, Silicium is used instead of Chromium.

Glass 2 mm/TiO₂ 55 nm/SiO₂ 100 nm/Si 30 nm

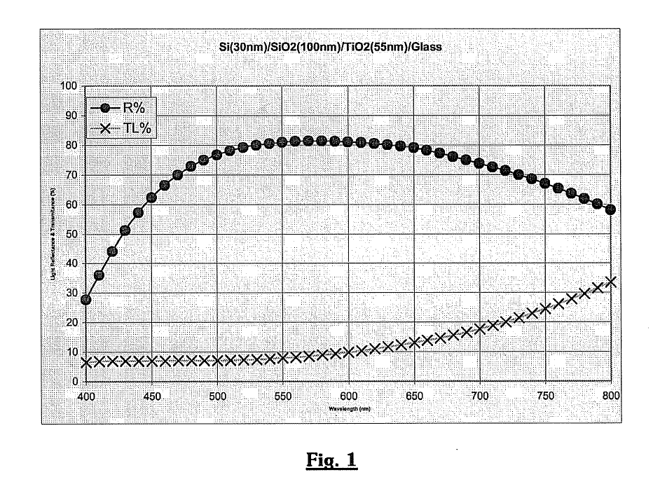

The following optical characteristics are obtained (see spectral data in FIG. 1)

| | |
|---|---|
| reflectance at 550 nm | 81% |
| transmittance at 550 nm | 8% |
| transmittance at 400 nm | 7% |
| transmittance at 700 nm | 18% |
| transmittance at 800 nm | 34% |

The Silicium refraction and absorption indexes over the visible and near infra red spectrum are such that a thinner layer may be used.

Simultaneously other interesting combinations also exist with the same materials when their respective thickness are in the range of

Glass (0.4 to 6 mm)/TiO₂ (55 to 100 nm)/SiO₂ (30 to 100 nm)/Si (15 to 50 nm)

### Example 3

Glass/TiO₂ (60 nm)/SiO₂ (60 nm)/Si (30 nm)

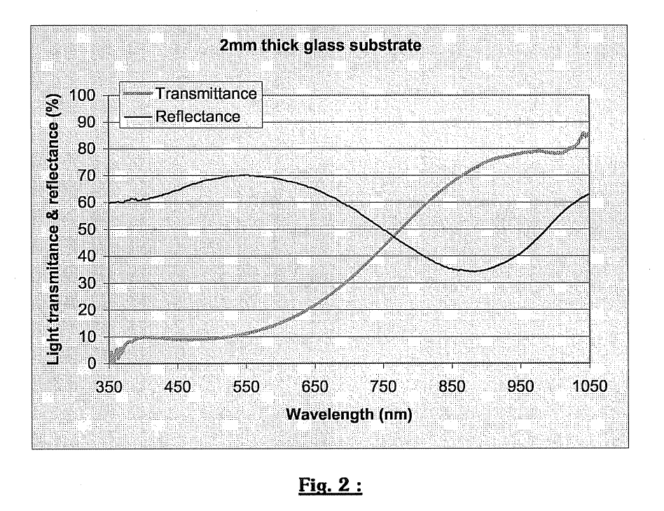

The following optical characteristics are obtained (see spectral data in FIG. 2):

| | |
|---|---|
| reflectance at 550 nm | 70% |
| transmittance at 550 nm | 12% |
| transmittance at 400 nm | 10% |
| transmittance at 700 nm | 31% |
| transmittance at 800 nm | 56% |

The coated substrate shows a neutral tint in reflection (a*=−8, b*=+9, purity is 8.5%)

### Example 4

Glass 2 mm/TiO₂ 60 nm/Si0₂ 60 nm/Si 15 nm

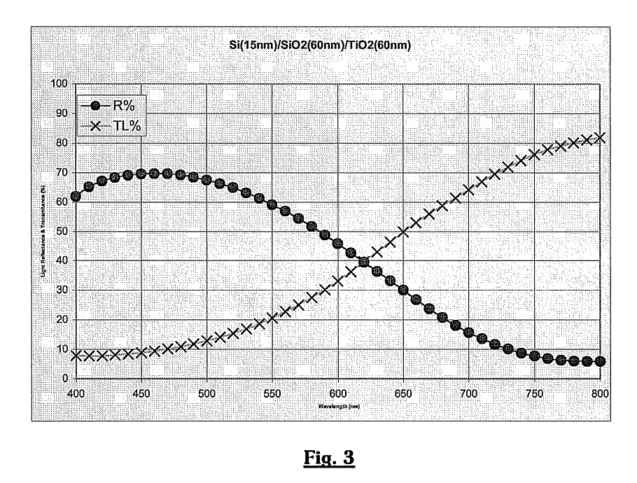

The following optical characteristics are obtained (see spectral data in FIG. 3)

| | |
|---|---|
| reflectance at 550 nm | 60% |
| transmittance at 550 nm | 20% |
| transmittance at 400 nm | 8% |
| transmittance at 700 nm | 64% |
| transmittance at 800 nm | 81% |

### Example 5

Glass 2 mm/TiO₂ 60 nm/SiO₂ 60 nm/Si 50 nm

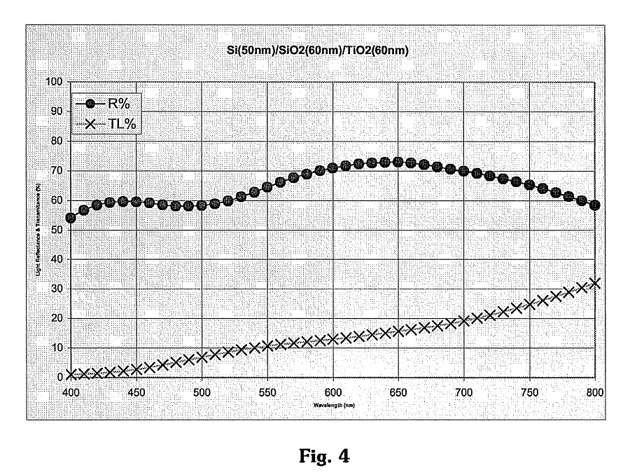

The following optical characteristics are obtained (see spectral data in FIG. 4)

| | |
|---|---|
| reflectance at 550 nm | 65% |
| transmittance at 550 nm | 11% |
| transmittance at 400 nm | 1% |
| transmittance at 700 nm | 19% |
| transmittance at 800 nm | 32% |

### Example 6

Glass 2 mm/TiO₂ 100 nm/SiO₂ 30 nm/Si 30 nm

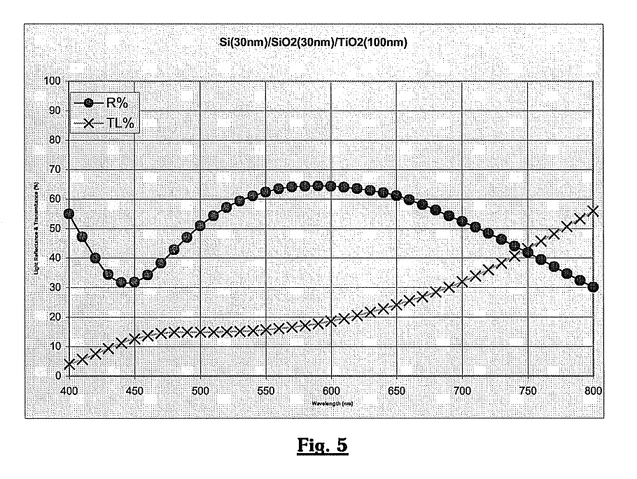

The following optical characteristics are obtained (see spectral data in FIG. 5)

| | |
|---|---|
| reflectance at 550 nm | 62% |
| transmittance at 550 nm | 16% |
| transmittance at 400 nm | 4% |
| transmittance at 700 nm | 32% |
| transmittance at 800 nm | 56% |

An alternative to above embodiments consists in the use of, instead of Silicium, Silicium doped with another metal in the amount of less than 15%.

Such mean being a classical choice in the state of the art in PVD to improve its deposition process, as long as the optical properties are not substantially affected, one can prefer to use doped Silicium, for example with 2% to 12% Aluminium combined with the Silicium, whether it is SiO2 or Si layer.

All our embodiments can receive on their uttermost rear face a coating of paint/enamel/other material, typically of a thickness above one micron to even further improve their mechanical/corrosion/anti shatter behaviour. Upon request suitable “windows” in front of display/emitter/sensor shall be placed locally.

1.-17. (canceled)

18. A vitreous substrate, having a front surface and a rear surface, coated on its rear surface with a stack of layers including, successively from the substrate,
i) one layer of a high refractive index material in the range of 1.9 to 2.8;
ii) one layer of a lower refractive index material in the range of 1.2 to 2;
iii) one layer of semiconductor material having a refractive index of more than 3;
wherein
(a) the refractive indexes of high refractive index materials and of the low refractive index materials differ at least by 0.2;
(b-1) the optical thickness of the layer of high refractive index material being lower than 260 nm; or
(b-2) the optical thickness of the layer of high refractive index material being lower than 250 nm;
(c-1) the optical thickness of the layer of lower refractive index material being lower than 240 nm; or
(c-2) the optical thickness of the layer of lower refractive index material being lower than 220 nm;
(d-1) the coated substrate having a transmittance at 550 nm of at least 6%, or
(d-2) the coated substrate having a transmittance at 550 nm of at least 8%; and
(e-1) the coated substrate having a reflectance at 550 nm greater than 45%, or,
(e-2) the coated substrate having a reflectance at 550 nm greater than 50%.

19. A coated substrate according to claim 18, characterised in that the optical thickness of the layer of high refractive index is
(b-3) between 85 and 240 nm, or
(b-4) between 100 and 225 nm.

20. A coated substrate according to claim 18, characterised in that the optical thickness of the layer of lower refractive index is
(c-3) between 50 and 180 nm, or
(c-4) between 60 and 170 nm.

21. A coated substrate according to claim 18, characterised in that it has
(f-1) a transmittance at 700 nm of 38% or less, or
(f-2) a transmittance at 700 mn of 35% or less, and
(g-1) a reflectance at 700 nm of at least 43%, or
(g-2) a reflectance at 700 nm of at least 45%.

22. A coated substrate according to claim 18, characterised in that it has
(h-1) a transmittance at 800 nm of 62% or less, or
(h-2) a transmittance at 800 nm of 60% or less, and
(j-1) a reflectance at 800 nm of at least 22%; or
(j-2) a reflectance at 800 nm of at least 25%.

23. A coated substrate according to claim 18, characterised in that the semiconductor material is selected from at least one of the following: silicon, chromium, germanium, titanium, aluminium, tungsten, nickel or any alloy of two or more of the foregoing.

24. A coated substrate according to claim 18, characterised in that the semiconductor material is
(k-1) silicon undoped and is at least partially crystallized, or
(k-2) silicon doped with 0 to 12% Al and is at least partially crystallized.

25. A coated substrate according to claim 18, characterised in that the high refractive index material is selected amongst titanium oxide, niobium oxide, aluminium nitride and silicon nitride.

26. A coated substrate according to claim 18, characterised in that the lower refractive index material is selected amongst silicon oxide, magnesium fluoride, tin oxide.

27. A coated substrate according to claim 18, characterised in that it has a neutral tint in reflection.

28. A coated substrate according to claim 18, characterised in that the colour in reflection presents
(m-1) a purity lower than 13%, or
(m-2) a purity lower than 10%.

29. A coated substrate according to claim 18, characterised in that the layer of semiconductor material has a geometrical thickness
(n-1) between 5 and 100 nm, or
(n-2) between 10 and 75 nm.

30. A coated substrate according to claim 18, characterised in that when the layer of semiconductor material is a Cr layer, its geometrical thickness is
(p-1) between 5 to 50 nm, or
(p-2) between 10 and 40 nm.

31. A coated substrate according to claim 18, characterised in that when the layer of lower refractive index material is a Si layer, its geometrical thickness is
(q-1) between 5 and 75 nm, or
(q-2) between 10 and 60 nm.

32. A coated substrate according to claim 18, characterised in that nature and thickness of the layer of semiconductor material is selected such that if the substrate were coated only with said layer, the substrate would have a LR measured on the non coated side of
(s-1) less than 50%, or
(s-2) less than 30%.

33. A coated substrate according to claim 18, characterised in that the layer of lower refractive index material has a geometrical thickness
(t-1) between 25 and 150 nm, or
(t-2) between 30 and 120 nm.

34. A coated substrate according to claim 18, characterised in that the layer of high refractive index material has a geometrical thickness
(u-1) between 20 and 150 nm, or
(u-2) between 25 and 125 nm.
